(19) United States
(12) Patent Application Publication
(10) Pub. No.: US 2017/0149303 A1
(43) Pub. Date: May 25, 2017

(54) DIGITALLY CONTROLLED MOTOR DEVICE WITH STORAGE

(71) Applicant: KERBS AutoTech Pty Ltd, Kingsgrove, New South Wales (AU)

(72) Inventor: Michael John Urch, Menai, New South Wales (AU)

(21) Appl. No.: 15/322,992

(22) PCT Filed: Jun. 29, 2015
(86) PCT No.: PCT/AU2015/000374

§ 371 Date: Dec. 29, 2016

(30) Foreign Application Priority Data
Jun. 30, 2014 (AU) 2014902495

(51) Int. Cl. H02K 7/02; F04B 17/03; B60K 6/30; H02K 11/30; H02K 7/00; H02K 7/14; H02K 7/18; H02K 11/215; B60L 11/16; B60W 10/26

(52) U.S. Cl. CPC H02K 7/025; B60L 11/16; F04B 17/03; B60K 6/30; B60W 10/26; H02K 7/006; H02K 7/14; H02K 7/1853; H02K 11/215; H02K 11/30; F03D 9/25

(57) ABSTRACT

A digitally controlled motor device with storage (1) comprises a stator and a flywheel (10) having an axis of rotation and being rotatably mountable on a shaft (60) of a rotating machine and having at least a first set of magnetic coils (13) arranged thereon; an induction rotor (20) having an axis of rotation and being mountable on the shaft in magnetic communication with the first set of magnetic coils of the flywheel such that a change in magnetic flux at the first set of magnetic coils induces a current in the induction rotor. At least one set of second magnetic coils (12) is arranged on the stator in magnetic communication with the induction rotor (20). A controller (30) controls a supply of electrical power from the flywheel (10) to the second set of magnetic coils (12) to force acceleration or deceleration of the induction rotor (20), whereby the induction rotor (20) is adapted to receive electrical power from the flywheel (10) via the first set of magnetic coils (13) and from the second set of magnetic coils (12).

### FIELD

The present invention relates to a digitally controlled motor device with storage for harnessing and storing energy from a decelerating rotating machine and supplying energy as the rotating machine accelerates again at high capacity.

The invention has been primarily developed for automobile racing engines such as are used in Formula 1, and will be described primarily in these terms. However, it is envisaged that the invention also has other applications such as in hybrid cars, transport vehicles (such as trucks, buses, trains and planes) and in the generation of electricity in wind turbines.

This patent application is related to the Applicant's corresponding Australian provisional patent application nos. 2014902498 filed on 30 Jun. 2014 and 2014903414 filed on 28 Aug. 2014 and to the corresponding International (PCT) patent application titled “An Internal Combustion Engine Heat Energy Recovery System” as filed on 29 June 2015, the entire contents of which are incorporated herein by reference.

### BACKGROUND

The price of energy, in particular oil based fuels such as petroleum and diesel that powers most of the vehicles on the road, ocean or air is steadily increasing. Large sectors of the economy are affected by the rising cost of transportation and governments are continually introducing more rigid environmental standards for emissions control.

As a result, considerable effort and investment has gone into developing hybrid vehicles. These vehicles use the internal combustion engine as a main source of power with power augmented by an electric motor. Other recent developments include fully electric cars, the performance of which is now comparable to petrol and diesel vehicles. However, the electrical energy used to power the vehicles is stored in batteries which are heavy, expensive and have a limited storage capacity. The operating range of an electric vehicle is accordingly limited and this has constrained the mainstream uptake of these vehicles.

A majority of hybrid/electric vehicles operate in a city environment with large amounts of traffic causing regular stopping and starting of the vehicle. The traditional method to slow down a vehicle is the use of disc or drum brakes that use friction pads to slow the vehicle. A large amount of energy is dissipated as heat during the deceleration process and is effectively wasted. Hybrid vehicles have the ability to operate their electric motors as generators when the vehicle is slowing and use regenerative braking to reclaim a proportion of the energy normally wasted in braking, store it and then use it to propel the vehicle when it accelerates. However, the amount of storage is limited by the instantaneous capacity of the batteries and at low speeds the changing magnetic flux in the generator reduces to ineffective levels meaning that only smaller proportions of the overall heat energy can be harnessed and stored at higher speeds.

Under acceleration, electric motors have a large instantaneous torque when starting from rest that is known as the “locked rotor” torque. This starting torque is large compared to the torque provided from an internal combustion engine starting from rest. The most effective operational configuration of a vehicle in hybrid mode is to predominantly use the electric motor for accelerating the vehicle from rest and then switch to predominantly use the engine at high speeds. The electric motor is then tuned for lower speeds and the engine tuned for high speeds. When combined, the internal combustion engine and the electric motor can produce a vehicle that is fuel efficient and also has very high performance.

The new 2014 regulations in Formula 1 allow the use of the “MGU-K” and “MGU-H” systems to respectively reclaim kinetic energy, directly from the transmission of the slowing vehicle, and heat energy, from the engine exhaust, and use this energy to directly propel the vehicle directly or electronically power the turbocharger and induce more air into the engine earlier than traditional turbochargers can to reduce “turbo lag”.

These newly developed racing cars have been performing well. However, there remains a need to recover lost energy at higher capacities while increasing vehicle efficiency and performance.

### OBJECTION OF INVENTION

It is the object of the present invention to substantially meet the above needs.

### SUMMARY OF INVENTION

There is disclosed herein a digitally controlled motor device with storage, comprising: a stator; a flywheel having an axis of rotation and being rotatably mountable on a shaft of the rotating machine and having at least a first set of magnetic coils arranged thereon; an induction rotor having an axis of rotation and being mountable on the shaft in magnetic communication with the first set of magnetic coils of the flywheel such that a change in magnetic flux at the first set of magnetic coils induces a current in the induction rotor; at least one set of second magnetic coils arranged on the stator in magnetic communication with the induction rotor; and a first controller for controlling a supply of electrical power from the flywheel to the second set of magnetic coils to force acceleration or deceleration of the induction rotor; whereby the induction rotor is adapted to receive electrical power from the flywheel via the first set of magnetic coils and from the second set of magnetic coils.

Preferably, the shaft is a drive shaft.

The device therefore advantageously utilises a rotating machine i.e. a flywheel spinning at high speeds to store energy (mechanically and magnetically) and uses the energy to provide significantly greater power and torque to an induction rotor and shaft of a motor. When utilised in a decelerating vehicle, power is directly fed from the induction rotor of the motor to the flywheel to accelerate it. When the induction rotor slows to very low levels, the flywheel is still spinning at high speed and able to provide large amounts of changing magnetic flux which can be converted into large amounts of negative or positive torque under regenerative braking or vehicle acceleration. Under regenerative braking, greater amounts of braking energy can be harnessed as the vehicle slows to a stop since the flywheel is always spinning and consistently provides large amounts of changing magnetic flux. The result is that the traditional mechanical vehicle brakes may be downsized and even used primarily as a backup to the device for safety. Under vehicle acceleration, the device is capable of supplying torque and power at much higher burst capacity compared to a traditional motor that starts operating with a high locked rotor current. In contrast, the power output of the digitally controlled motor device with storage increases without excessive high locked rotor currents and its associated energy losses and heat issues.

The magnetic flux and associated electrical power experienced by said second set of magnetic coils is at an angular velocity ω_{RF} that is equal to the velocity of the induction rotor ω_{R} relative to the angular velocity of the flywheel ω_{F} and governed by the equation:

ω_{RF}=ω_{R}−ω_{F}

Controlling the excitation frequency of power sent to the second set of magnetic coils controls the power transferred between the flywheel and the induction rotor either to charge (accelerate) the flywheel if the frequency of the controlled power leads the power experienced at the second set of magnetic coils or discharge (decelerate) the flywheel if the frequency of said controlled power is lagging the power experienced at the second set of magnetic coils. The controller feeds a voltage and frequency electrical signal such as 10 kW of power at the second set of magnetic coils therefore controls the rate of charging or discharging of the flywheel. The large storage contained in the spinning inertia and magnetic field of the flywheel provides a burst capacity such as 20 kW so that under acceleration the first set of flywheel coils can feed 20 kW into the rotor and the second set of magnetic coils can feed 10 kW into the rotor with the net result of 30 kW or three times the typical 10 kW a traditional electric motor may provide, especially at rest with much higher torque.

When operated primarily as a generator, mechanical power is transferred to the rotor at varying speeds. Controlling the speed of the flywheel determines the angular velocity and frequency of power generated at the second set of magnetic coils to provide electrical power at substantially fixed frequency and voltages ready for consumption or connection to the grid without using power conditioners. This can potentially provide benefits for electricity generation, particularly in large renewable energy generation systems. For example low cost, high quality electricity may be generated with fewer harmonics than is normally associated with switched power conditioners, with no requirement for power factor correction. A network of large multi-megawatt device generators can be connected and digitally controlled with the aim of addressing issues with grid systems such as voltage drops, brownouts, blackouts and power factors.

In an embodiment, the drive shaft is a drive shaft of a vehicle. In another embodiment, the drive shaft is adapted for driving a compressor.

Preferably, a third set of magnetic coils is arranged on the flywheel and in electrical communication with the first controller for the transfer of electrical power to and from the flywheel.

Preferably, the device further includes an external electrical power storage device, the first controller adapted to supply electrical power from the external electrical power storage device to the flywheel or to transfer electrical power stored in the flywheel to the external electrical power storage device, the first controller being adapted to control the speed of rotation of the flywheel by controlling an amount of power supplied to the third set of magnetic coils.

Preferably, the device further includes a second controller adapted to supply electrical power to the induction rotor via the second set of magnetic coils.

Preferably, each of the first controller and the second controller is a digitally controlled switched brushless motor controller.

Preferably, the first controller and the second controller each include an induction rotor position sensor and an induction rotor speed sensor. More preferably, the first and second controllers include at least one rotary encoder and/or magnetic hall sensor.

Preferably, the first controller and the second controller are in electrical communication with each other.

Preferably, the device includes a fourth set of magnetic coils connected to the stator in electrical communication with the external electrical power storage device for transfer of electrical power to or from the flywheel via the third set of magnetic coils.

Preferably, the external electrical power storage device is a battery or a super capacitor.

Preferably, the device includes at least one bearing connected to the stator for supporting the flywheel in controlled rotation about its axis of rotation.

Preferably, the magnetic coils are permanent magnets. Alternatively, the magnetic coils are induction coils.

Preferably, the drive shaft has an axis of rotation and the device includes at least one bearing connected to the stator for supporting the drive shaft in controlled rotation about its axis of rotation.

Preferably, the first, second, third and fourth sets of magnetic coils and the induction rotor are arranged in a radial flux configuration.

Alternatively, the third and fourth set of coils may be arranged in a transverse flux configuration.

Preferably, the stator includes an enclosure around the device components. Preferably, the enclosure and stator includes a mechanical seal to seal the induction rotor, flywheel and drive shaft therein. Preferably, the apparatus further includes a non-return valve and a vacuum pump adapted for placing the enclosure and stator under a full or partial vacuum. This reduces any fluid friction on the flywheel as it spins and thereby increases the efficiency of its energy storage. Preferably, the apparatus includes a water jacket arranged outside the stator and enclosure. The water jacket absorbs heat generated inside the stator and enclosure by the magnetic coils and the induction rotor. Alternatively the enclosure is hermetically sealed and a magnetic coupling is used to transmit power from inside the enclosure to an external shaft thereby eliminating mechanical seals.

In an embodiment, the induction rotor is operatively associated with a plurality of turbine rotor blades for rotational movement therewith as the turbine blades are rotated by fluid movement such as air (wind) or water.

In an embodiment, the number of coils in the first set of magnetic coils differs from the number of coils in the third set of magnetic coils so as to produce a geared ratio of the coils installed on the flywheel. Preferably, the number of third magnetic coils is a multiple of the number of first magnetic coils. In this manner, excitation of the flywheel by the fourth set of magnetic coils can occur at a different frequency than excitation of the flywheel at the first set of magnetic coils, allowing for increased control of the flywheel speed and optimisation of power transfer to and from the flywheel.

In an embodiment, the induction rotor has a flywheel side in electrical communication with the first set of magnetic coils and a stator side in electrical communication with the second set of magnetic coils. Preferably, the induction rotor has a first number of induction coils at the flywheel side thereof and a second number of induction coils at the stator side thereof. Preferably, the number of induction coils on the stator side is different to the number of induction coils on the flywheel side. Preferably, the number of induction coils on the stator side is a multiple of the number of coils on the flywheel side. This allows the induction rotor to transmit electrical power from the flywheel at a different frequency to that at which it is received by the rotor by a large factor such as 20 times thereby optimising power transfer. In this manner, it is possible to transfer large amounts of electrical power between the flywheel and the rotor due to the gearing of the coils in the induction rotor.

In an embodiment, the device consists of a first section that includes a first enclosure and the flywheel and a separate second section that includes a second enclosure and the induction rotor. The device further includes a connection circuit board arranged in electrical communication with each of the flywheel and the induction rotor. Preferably, the first section includes a fifth set of magnetic coils mounted on the enclosure in magnetic communication with the first set of magnetic coils of the flywheel. Preferably, the second section includes a sixth set of magnetic coils mounted on the second enclosure in magnetic communication with the induction rotor. Preferably, the connection circuit board is adapted to transmit electrical power from the fifth set of magnetic coils to the induction rotor via the sixth set of magnetic coils. In this configuration, the flywheel can be positioned separately from the induction rotor in a more suitable location in the vehicle or other device in which the device is to be used, for example for better weight distribution.

In another embodiment, the device includes a connection circuit board located inside the induction rotor, the connection circuit board being adapted to transmit electrical power between the flywheel first set of magnetic coils and the induction rotor via the second set of magnetic coils. This embodiment therefore creates a split of the induction rotor into a flywheel side set of coils that is wired to the connection circuit board which is also wired to a stator side set of coils.

Preferably the connection circuit board is controlled wirelessly via either of the first controller or the second controller located outside of the stator.

Preferably, the connection circuit board includes a programmable logic controller adapted for conditioning of electrical power transmitted between the flywheel and the induction rotor. Preferably, the programmable logic controller is adapted to control a plurality of electrical and/or mechanical switches to obtain a change in frequency and voltage of electrical power transmitted through the induction rotor.

This aspect of the device has the advantage that the switches can be configured to create many different gear ratios with the potential for an electric constantly variable transmission (CVT) capable of transferring large amounts of power between the flywheel and the induction rotor.

The precise nature of the digital control system and/or associated signal conditioning between the flywheel and the induction rotor inside the rotor allows the device to operate as an electric gearbox either with a static gearing or with a constantly variable transmission with nearly infinitely variable gearing using the connection circuit board electronics or as an electric clutch via the switching on/off of signal conditioning.

Preferably, the programmable logic controller is adapted to control a plurality of variable capacitors for obtaining a change in the voltage, current level and frequency at the induction rotor such that the current leads the voltage to cause a magnetic flux in the induction rotor of variable frequency and magnitude.

In another embodiment, the programmable logic controller has a plurality of variable inductors, variable resistors and variable capacitors and is adapted to control the current, voltage level and frequency of the plurality of variable inductors, resistors and capacitors such that the current leads or lags the voltage at the induction rotor such that the current creates a magnetic flux in the induction rotor of variable frequency and magnitude.

Preferably the variable capacitors and/or the variable inductors further function to store electrical power.

An advantage of each of these configurations is that the apparatus can be configured to operate at precisely controlled high capacities when the flywheel is charging or discharging or to provide fixed frequency and voltage supply ready for consumption or grid connection when the apparatus operates as a generator, without the need for power converters.

### BRIEF DESCRIPTION OF DRAWINGS

Preferred forms of the present invention will now be described by way of example with reference to the accompanying drawings wherein:

FIG. 1 is a half sectional schematic of a first embodiment of a digitally controlled motor with storage with a radial flux configuration;

FIG. 2 is a half sectional schematic of a second embodiment of a digitally controlled motor with storage with a hybrid flux configuration;

FIG. 3 is a half sectional schematic of a third embodiment in which the device is turbine driven;

FIG. 4 is a half sectional schematic of the flywheel and induction rotor both with static gears;

FIG. 5 is a half sectional schematic of the flywheel separated from the induction rotor;

FIG. 6 is a schematic of the digitally controlled motor with a connection circuit board located on the induction rotor;

FIG. 7 is a schematic of the connection circuit board in a programmable logic controller configuration with switches;

FIG. 7a shows example schematic wiring diagrams of the connection circuit board 3 of FIG. 7;

FIG. 8 is a schematic of the connection circuit board in a programmable logic controller configuration with variable capacitors; and

FIG. 9 is a schematic of the connection circuit board in a programmable logic configuration with variable inductors, resistors and capacitors.

### DESCRIPTION OF EMBODIMENTS

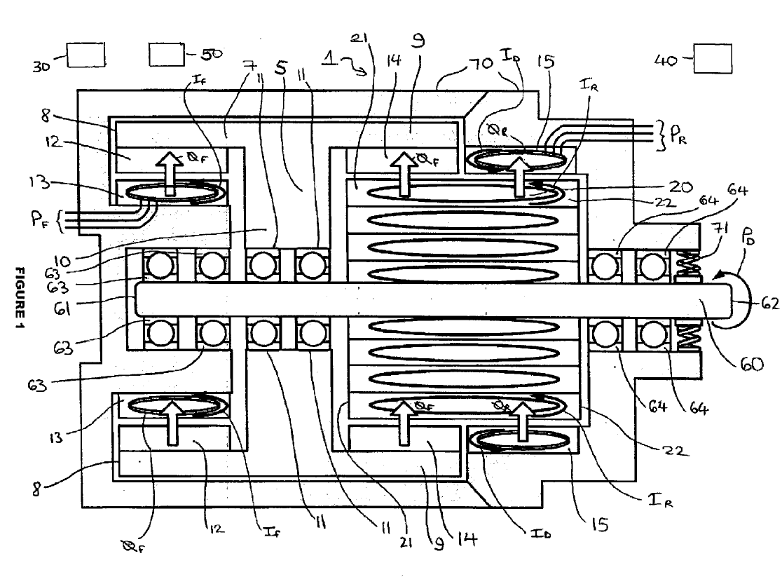

FIG. 1 shows a first embodiment of a digitally controlled motor device with storage 1 in accordance with the disclosure, the device 1 including a flywheel 10, an induction rotor 20, a first digital power controller 30, a second digital power controller 40 and an external power storage device 50. The flywheel 10 and induction rotor 20 are housed inside a stator enclosure 70 that can be used to secure the apparatus to a stable mounting.

The flywheel 10 is rotatably mounted on a drive shaft 60 of a vehicle or other machine to be operated by the device 1 via the drive shaft 60. The drive shaft 60 has a proximal end 61 and a distal end 62. The proximal end 61 of the drive shaft 60 is supported by a pair of bearings 63 configured to allow the shaft to rotate about its axis in a controlled manner. The distal end 62 of the drive shaft is supported by a pair of bearings 64. The bearings 63, 64 are mounted on the stator housing 70 such that the drive shaft 60 is supported within the stator housing 70.

The flywheel 10 consists of a central portion 5 that is rotatably supported towards the proximal end 61 of the drive shaft 60 by a pair of bearings 11 that are mounted on the stator housing 70. The flywheel also has a peripheral flange 7 that extends forwardly and rearwardly from the central portion 5 to form a stator side 8 and a rotor side 9. The stator side 8 of the flywheel flange 7 has a stator side set of magnetic coils 12 such as permanent magnets or induction coils mounted thereon and configured to face radially inwardly towards the drive shaft 60. A set of flywheel magnetic coils 13 is mounted on the stator housing 70 configured to face radially outwardly adjacent to the first set of magnetic coils 12 and in magnetic communication therewith.

The flywheel further includes a rotor side set of magnetic coils 14 mounted at the rotor side 9 of the flange 7 that are configured to face radially inwardly towards the drive shaft 60.

The induction rotor 20 is connected to the drive shaft 60 adjacent the flywheel 10 towards the distal end 62 of the drive shaft 60 so as to be rotatable therewith. The induction rotor 20 has a flywheel side 21 adjacent the flywheel 10 and a stator side 22 adjacent the stator housing 70 and consists of a plurality of induction coils 16 extending from the flywheel side 21 to the stator side 22. The flywheel side 21 of the induction rotor 21 is in magnetic communication with the rotor side set of magnetic coils 14 of the flywheel 10. The stator side 22 of the induction rotor is in magnetic communication with a set of rotor coils 15 mounted on the stator housing 70.

One or more mechanical seals 71 seals the distal end 62 of the drive shaft 60 to the stator housing 70 to provide a sealed enclosure around the component parts of the apparatus. A non-return valve 72 and a vacuum pump 73 are installed in the stator housing 70 to provide a full or partial vacuum within the stator housing 70 so that air resistance acting on all rotating components is minimised or alleviated. The mechanical seal 71 therefore seals the vacuumed space from the ambient atmosphere.

The first digital power controller 30 is a digitally controlled brushless motor controller shown only schematically in the Figures. The first digital power controller 30 is adapted to transfer electrical power P_{F} from the external power storage device 50 (such as one or more batteries or super capacitors) to the flywheel 10 and control its rotational speed via the stator side set of magnetic coils 12. This power generates a current in the flywheel coils 13 as depicted by the arrow I_{F} which creates a magnetic flux as depicted by the arrow Φ_{F}. This magnetic flux is in communication with the flywheel stator side coils 12 and creates a force on them to accelerate the flywheel 10. The first digital controller 30 can also be configured to operate the device 1 in reverse (i.e. In a regenerative braking mode) to draw power from the flywheel 10 to provide flux to induce a current in the flywheel coils 13 that transmits power to the first digital controller 30 and from there to either the external power storage device 50 or to the second digital controller 40 as explained below.

The second digital power controller 40 is also adapted to transfer electrical power P_{R} to the induction rotor 20 to control its rotational speed. The electrical power P_{R} generates a current I_{D} at the rotor coils 16 that creates a magnetic flux as depicted by the arrow Φ_{R}. This magnetic flux induces a current as depicted by the arrow I_{R} in the rotor induction coils. A similar magnetic flux Φ_{F} is generated at the rotor side set of magnetic coils 14. This magnetic flux Φ_{F} also induces a current in the rotor induction coils 16 as depicted by the arrow I_{R}. It is the interaction between these currents I_{R} and power that dictates whether the induction rotor 20 accelerates or decelerates from the direct interaction with the flywheel 10. That is, if the current and power from the flywheel 10 leads the current and power in the induction rotor 20, then electrical power is transferred from the flywheel 10 to the induction rotor 20. If the current and power from the flywheel 10 lags the current and power from the induction rotor 20, then the rotor 20 provides power transfer to the flywheel 10.

The device of FIG. 1 can advantageously be operated to provide mechanical drive P_{D} to an external device (for example a vehicle or a compressor) via the drive shaft 60 and can be used to accelerate or decelerate the drive shaft 60. The device can also be used to generate electrical power via accepting power from the rotating drive shaft 60 and converting it to usable power for storage or for supply to a power grid.

When mechanical power is required at the drive shaft 60, for example when a vehicle is to be accelerated from rest, the first digital power controller 30 is configured to provide power from the external power storage device 50 to the flywheel 10 to accelerate it to high speed. The flywheel 10 induces a current in the rotor coils 16 of the induction rotor 20 via the magnetic coils 14. Simultaneously, the second digital power controller 40 is configured to transfer electrical power to the induction rotor 20. Therefore, under acceleration the induction rotor 20 and hence the drive shaft 60 can be provided with electrical power from three sources simultaneously with the corresponding potential to provide up to three times the amount of torque to the drive shaft 60 in comparison to a standard electric motor powered by a single source.

The first digital controller 30 and the second digital controller 40 are configured to communicate with each other to provide a smooth acceleration of the drive shaft 60 (and hence of the vehicle or other device to be accelerated). Each of the controllers 30, 40 is programmed with the number of poles and alignment (to calibrate them to feedback encoders) on the stator side of the flywheel 10 and the stator side of the rotor 20. The controller 30 is adapted to accept feedback in respect of the angular position of the rotor side of the flywheel 10 so that the controller can accurately excite the respective flywheel coils 12, 14 and rotor coils 15, 16. The controllers 30, 40 are programmable to provide electrical power at a desired frequency and voltage to ensure that the interaction of the magnetic fluxes Φ_{F} and Φ_{R} between the flywheel 10 and the induction rotor 20 provides constructive interference whereby the power and current from the flywheel 10 leads the corresponding power and current from the induction rotor 20 to provide power to the induction rotor 20. The physical effect of this is to decelerate the flywheel 10 from high speed to a medium speed such that the flywheel discharges the kinetic energy stored therein to accelerate the induction rotor 20 and provide torque to it. An advantage of this use of the device 1 is that as the induction rotor 20 is at rest and the flywheel 10 is charged up and spinning at high speed, the flywheel can then provide significant change in magnetic flux to accelerate the rotor very quickly in comparison to a conventional motor, which uses a large amount of power, known as locked rotor current, to overcome the inertia of the rotor, resulting in a smaller change in magnetic flux provided to accelerate its rotor from rest.

To decelerate the drive shaft 60, for example if it is required to slow down a vehicle to rest, the second digital power controller 40 operates in its regenerative braking mode to withdraw power from the rotor 20 and operate it as a power generator. The power drawn from the induction rotor 20 is transferred to the first digital power controller 30 to accelerate the flywheel 10 such that it stores charged power at the external power storage device 50. As such, the apparatus provides deceleration of the rotor 20 and hence the drive shaft 60 by drawing power from the three power sources—the first digital power controller 30 charges the external power storage device 50, the second digital power controller 40 draws power from the induction rotor 20 for storage at the or a further external power storage device 50 and both the first and second controllers 30, 40 can accelerate and charge up the flywheel 10 to its maximum speed before transferring the power stored therein to the external storage 50. The rotor 20 also directly transfers power to the flywheel 10 via the magnetic coils 14.

When operating as a motor device as described above, the flywheel 10 typically spins at high speeds such as 60,000 RPM or 120,000 RPM. The induction rotor 20 typically spins at medium speeds of e.g. 10,000 RPM or 20,000 RPM. The flywheel 10 typically has 2 or 4 poles as the change in magnetic flux occurs at a high frequency and the rotor 20 typically has 12 or 24 poles to match the frequency of the change in magnetic flux of the flywheel operating at a 6:1 speed ratio. The flywheel 10 is normally spun in the same direction as the induction rotor 20 so that the frequency level and the change in magnetic flux between them is reduced and the flywheel 10 rotational forces applied to the drive shaft 60 via the bearings 63 would assist in dragging the induction rotor 20 around with it. However, slower speed rotors and flywheels are typically adapted to spin in opposite directions to increase the frequency and the change in magnetic flux between the induction rotor 20 and the flywheel 10.

To operate the device 1 in generator mode to generate electrical power, the drive shaft 60 rotates, generally at variable speed, to provide power to the induction rotor 20. The first digital power controller 30 and the second digital power controller 40 interact to control the relative speeds of the induction rotor 20 and the flywheel 10 to ensure that the flywheel 10 rotates at a controlled constant speed. The electricity P_{F} generated at the flywheel 10 is thereby supplied at a fixed frequency e.g. 50 Hz or 60 Hz. The voltage generated by the device 1 is also kept constant at e.g. 230V or 110V. This is achieved by using the external digital power storage device 50 as a means of balancing the load and the input power into and out of the induction rotor 20. An advantage of this aspect of the device 1 is that electrical power can be generated at substantially fixed frequency and voltage without the use of an external power converter, for example a rectifier. The flywheel 10 can be utilised as a load levelling device and the system complexity is reduced, leading to potential efficiencies in cost.

The rotor 20 includes a switching mechanism (not shown and preferably inside the induction rotor) between the flywheel side 21 and the rotor side 22 thereof, effectively splitting the induction rotor into two separate coils (one on the flywheel side and one on the rotor side), that can be operated via the first digital power controller 30 and/or the second digital power controller 40 to act like an electric clutch to open circuit the induction rotor 20 so that the current flowing in the normally short circuited induction rotor 20 cannot flow. When the switch is closed, the current flows in the short circuited induction rotor 20 to enable power transfer between the rotor 20 and the flywheel 10. The switch can be opened when the rotor is at rest or is spinning at constant speed to prevent the rotor 20 interacting with the flywheel 10, decelerating it such that it discharges and wastes energy. In this manner, the device can also be configured to operate as an electric clutch by and this precise control of mechanical power has the potential to improve many vehicle systems such as anti-lock braking (ABS) and traction control.

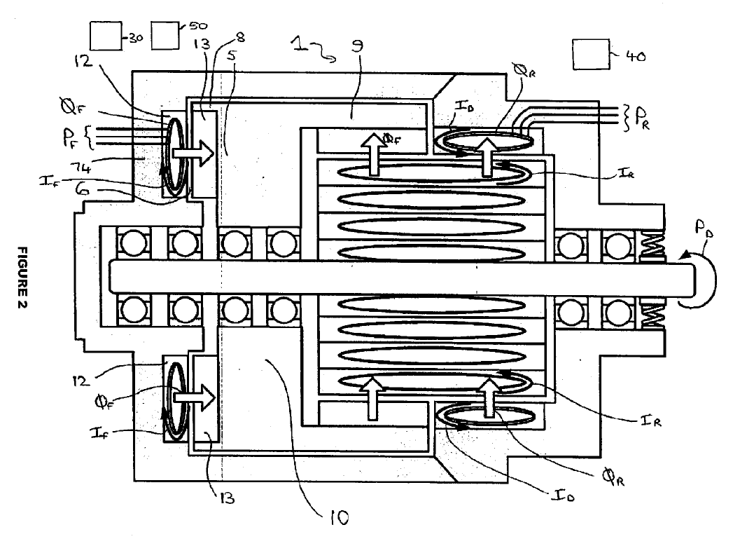

FIG. 2 shows a variation of the device 1 of FIG. 1 in which the flywheel coils 13 are configured axially on the stator side of the flywheel central portion 5. The magnetic coils 12 are located in an axial configuration on a proximal end 74 of the stator enclosure 70. In this configuration, the stator side of the flywheel flange 8 can be greatly reduced in size, reducing the size of the device 1 in the axial direction. Furthermore, an air gap 6 between the flywheel coils 13 and the magnetic coils 12 is easier to control in the axial direction as during use the flywheel 10 and the enclosure 70 will typically heat up and expand in the radial direction, changing the size of the air gap 6 in the configuration of FIG. 1.

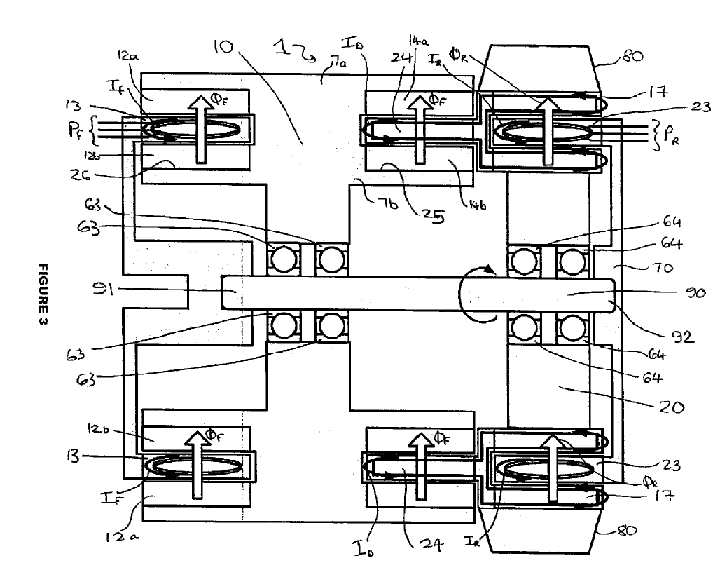

FIG. 3 shows a further variation of the device of FIG. 1 in which a plurality of rotor blades 80 such as turbine blades is arranged in magnetic communication with a circumference of the induction rotor 20. The drive shaft 60 is replaced with a non-rotatable axle 90, supported at a proximal end 91 thereof by the bearings 63 and at a distal end 92 thereof by the bearings 64. The axle 90 is enclosed within the stator housing 70. The flywheel 10 is connected to the bearings 63, 64 for rotation about the axle 90. In this embodiment, a set of magnetic coils 17 is connected to the rotor 20 circumference in a radial configuration. The set of magnetic coils 17 has a U shape, one arm of which is connected to the induction rotor 20, the other of which is connected to the rotor blades 80. The stator housing 70 has a set of magnetic coils 23 connected thereto in a radial configuration such that the coils 23 are arranged to extend inside the U-shaped set of magnetic coils 17 for magnetic communication therewith. The set of magnetic coils 17 further includes a longitudinally extending set of coils 24 that extend from a base of the U-shaped coils 17 axially towards the flywheel 10 and which rotate with the magnetic coils 17.

The peripheral flange 7 of the flywheel 10 consists of two flanges 7a and 7b arranged in spaced relation with one another to create an annular recess 25 therein at the rotor side 9 of the flywheel 10 and an annular recess 26 at the stator side of the flywheel 10. The recess 25 accommodates two sets of magnetic coils 14a, 14b arranged in a radial configuration facing one another inside the recess 25 and creating a space therebetween into which the magnetic coils 24 extends. The magnetic coils 24 are thereby in magnetic communication with the flywheel coils 14a, 14b. The recess 26 accommodates two sets of magnetic coils 12a, 12b arranged in a radial flux configuration at the stator side 8 of the flywheel 10. The set of stator coils 13 is arranged in a radial flux configuration to extend between the two sets of flywheel coils 12a and 12b so as to be in magnetic communication therewith.

The induction rotor 20 is free to rotate about its axis controlled by the bearings 64 at its centre that are connected to the axle 90. During use, rotation of the rotor blades 80 generates a current I_{R} in the magnetic coils 17 which creates a magnetic flux Φ_{R}. The magnetic flux Φ_{R} causes the induction rotor 20 to rotate at a slow variable speed in the order of 70 RPM. The magnetic coils 24 rotate with the coils 17 and generate a current I_{D} and a magnetic flux Φ_{F}. The magnetic flux Φ_{F} is in magnetic communication with the flywheel coils 14a, 14b, creating a force on them and accelerating the flywheel 10. Power stored in the charged flywheel 10 is transferred to the first digital power controller 30 as in the first embodiment.

The embodiment of FIG. 3 is generally used for slow rotors such as a wind turbine. The flywheel 10 and the induction rotor 20 are configured to spin in opposite directions to increase the frequency and the change in magnetic flux between them without any flywheel power being transmitted via the bearings 63 to the rotor 20 via the stationary axle 90.

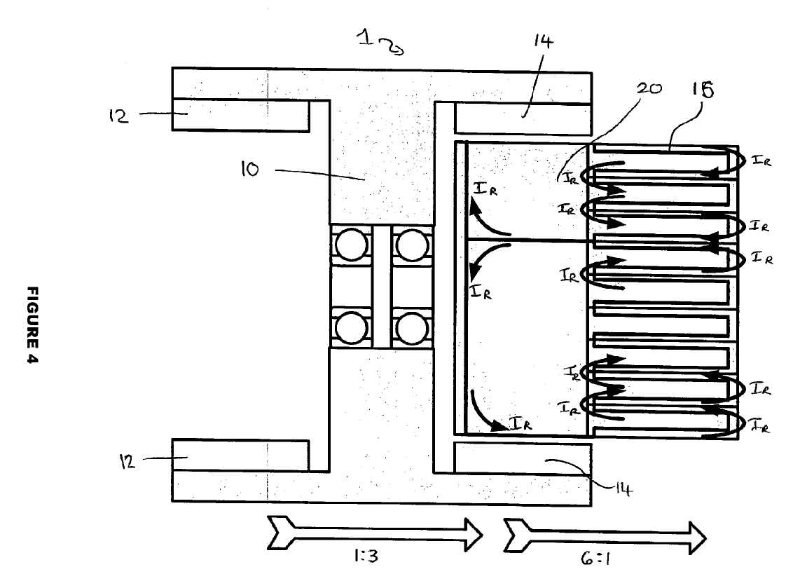

FIG. 4 shows an embodiment of the device of FIG. 1 in which only the flywheel 10 and induction rotor 20 are shown for clarity. This embodiment can be used in any of the configurations of FIGS. 1 to 3. The flywheel 10 and rotor 20 are configured in a static geared configuration. The first set of magnetic coils 12 on the stator side of the flywheel 10 has 12 poles. The set of magnetic coils 14 on the rotor side of the flywheel 10 has only 4 poles. A gear ratio of 1:3 is therefore established between the stator side 8 of the flywheel 10 and the rotor side 9. The induction coils 16 of the induction rotor 20 are set up with three coils at the flywheel side thereof and 18 coils that act like electromagnets with 18 poles on the stator side thereof, creating a static gearing of 1:6 between the flywheel side and the stator side of the rotor. These static gear ratios enable the flywheel 10 and induction rotor 20 to be operated at vastly different speeds whilst maintaining the same or similar frequency and change in magnetic flux.

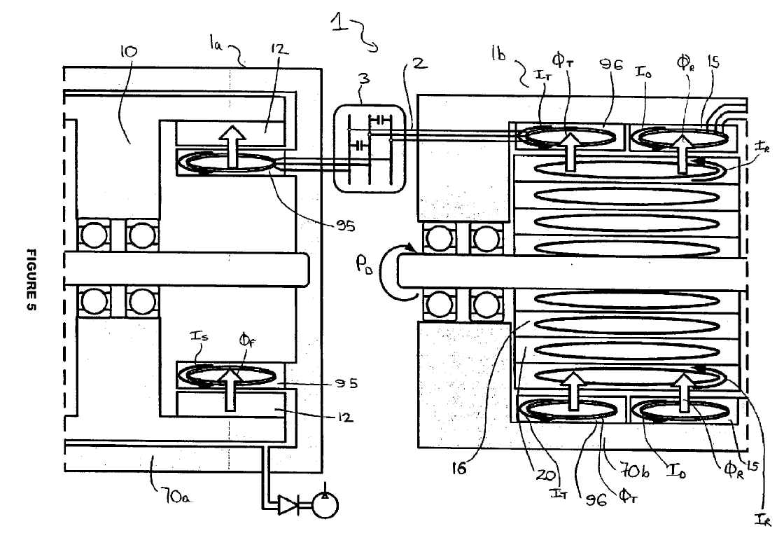

FIG. 5 schematically depicts a variation on the device of FIG. 1 that can also be applied to the configurations of FIGS. 2, 3 or 4. The flywheel 10 and the induction rotor 20 are located in two separate portions 1a, 1b of the apparatus 1. The two portions of the apparatus 1a, 1b can be in different locations that are electrically connected together using wires 2 and a connection circuit board 3. The flywheel 10 is housed in a first stator enclosure 70a. The induction rotor 20 is housed in a second stator enclosure 70b. A separate set of flywheel coils 95 is arranged on the stator housing 70a in magnetic communication with the permanent magnets 12 of the flywheel 10. The separate set of flywheel coils 95 is used to transfer an induced current I_{S} from the permanent magnets 12 through the wires 2 which then power a separate set of rotor coils 96 arranged on a flywheel side of the stator housing 70b to generate a magnetic flux Φ_{T} and induce a current I_{T} in the rotor coils 15. The connection circuit board 3 includes at least one or more of a relay, transistor, variable capacitor, variable resistor or variable inductor or a combination thereof. The device of FIG. 5 is otherwise identical to that of FIG. 1 and operates in the same way.

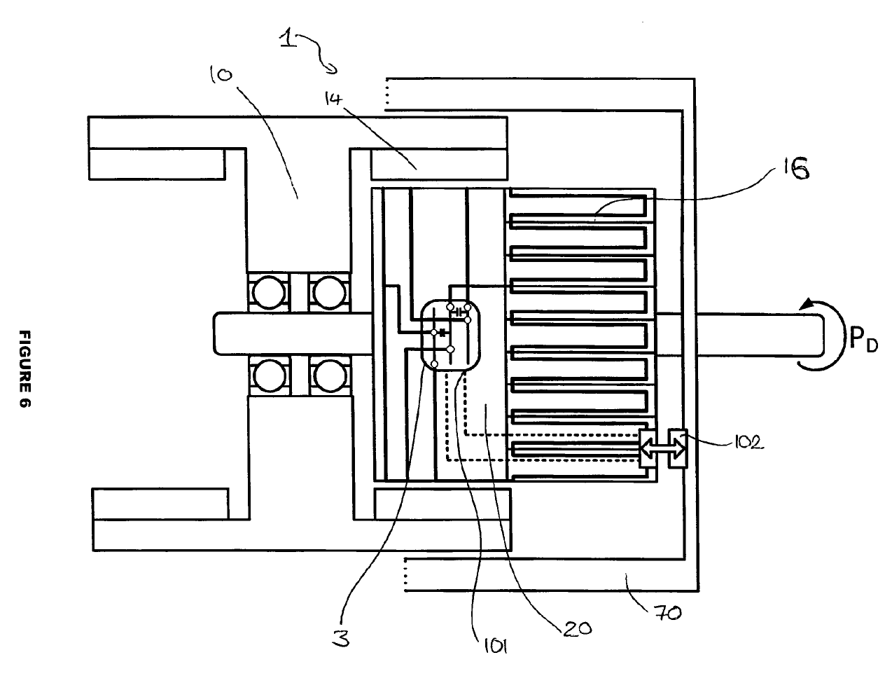

In an alternative embodiment to that of FIG. 5 shown in FIG. 6, the device 1 is configured in a single location as in FIG. 1. However, it includes a connection circuit board 3 located inside the induction rotor 20 near its axis of rotation such that it rotates with the rotor 20. The connection circuit board includes a rotor signalling device 101. The stator enclosure 70 includes an enclosure signalling device 102. The rotor signalling device 101 and the enclosure signalling device 102 are adapted to transmit and receive wireless signals such as wireless internet, Bluetooth or magnetic signals to actuate the switches, variable capacitance, variable resistors and variable inductance devices on the connection circuit board 3 with electrical power drawn directly from the rotor induction coils 15. Alternatively, the signalling devices 101, 102 use magnetic induction to transmit power wirelessly from the enclosure 70 to the induction rotor 20.

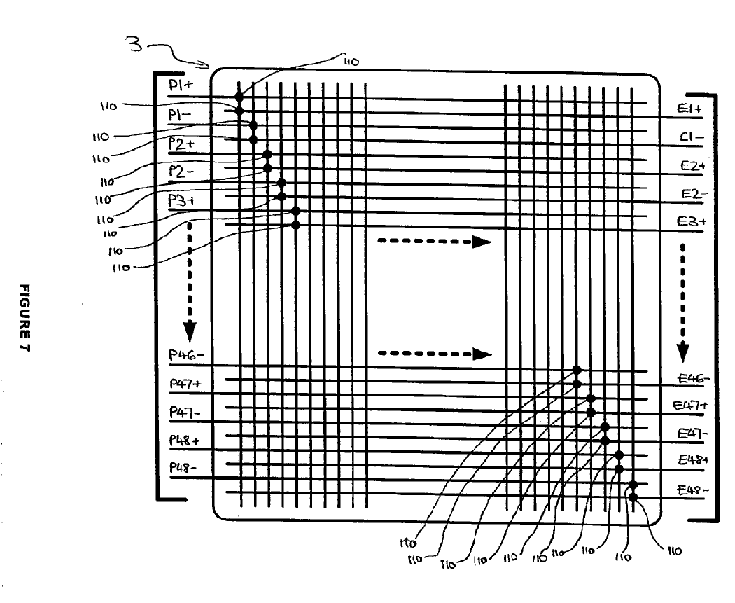

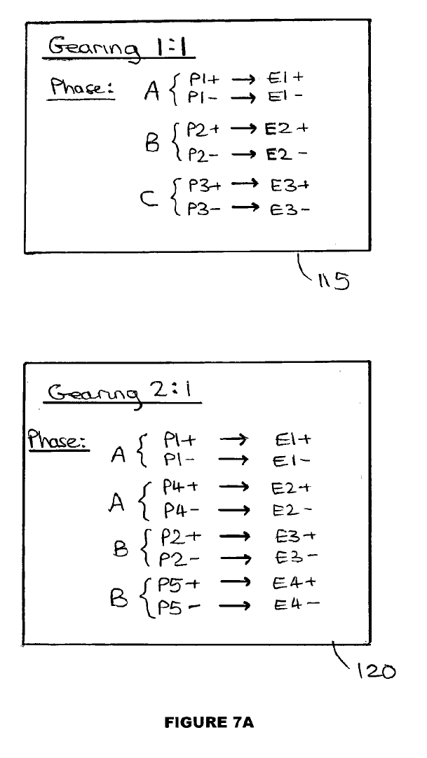

An example embodiment of the connection circuit board 3 of FIGS. 5 and 6 is shown schematically in FIG. 7. At the power coil side of the connection circuit board 3 are shown 96 power connections from 48 flywheel power coils such as magnetic coils 14, labelled P1+, P1−, up to P48+ and P48−. At the excitation coil side of the connection circuit board 3 are shown a corresponding 96 connections from 48 rotor excitation coils, such as magnetic coils 15 labelled E1+, E1−, up to E48+ and E48−. Switches 110 in the circuit board are arranged in a matrix configuration with horizontal connections able to switch to the vertical connections. The switches 110 are wirelessly controlled by a programmable logic controller such as the digital controller 40 or 50, to create any number of wiring combinations. The switches 110 are typically one or more of relays with mechanical contacts, and/or MOSFETS or IGBTs as is known in the art.

The switching configuration shown in FIG. 7 by the switches 110 indicates a connection in the matrix creates a wiring combination of each power coil P1+, P1−, P2+, P2− etc. directly connected to each excitation coil E1+, E1−, E2+, E2− etc. to create a simple 1:1 gear ratio between the sets of coils as indicated in the wiring chart 115 seen in FIG. 7a. By controlling the switching on and off, the connection circuit board 3 acts like an electric clutch to open or close the circuit connection in the rotor induction coils 16. Alternatively, the switches can be connected in a 2:1 gear ratio by connecting the power coils P1+, P1−, P4+, P4− to the excitation coils E1+, E1−, E2+, E2−. The wiring chart 120 seen in FIG. 7a shows the configuration for a 2:1 gearing. There is more than 9.83×10²⁹⁹ wiring combinations available in this embodiment. Accordingly, it is envisaged that specific wiring combinations will be able to perform many useful functions such as a constantly variable transmission (CVT) with literally billions of gears.

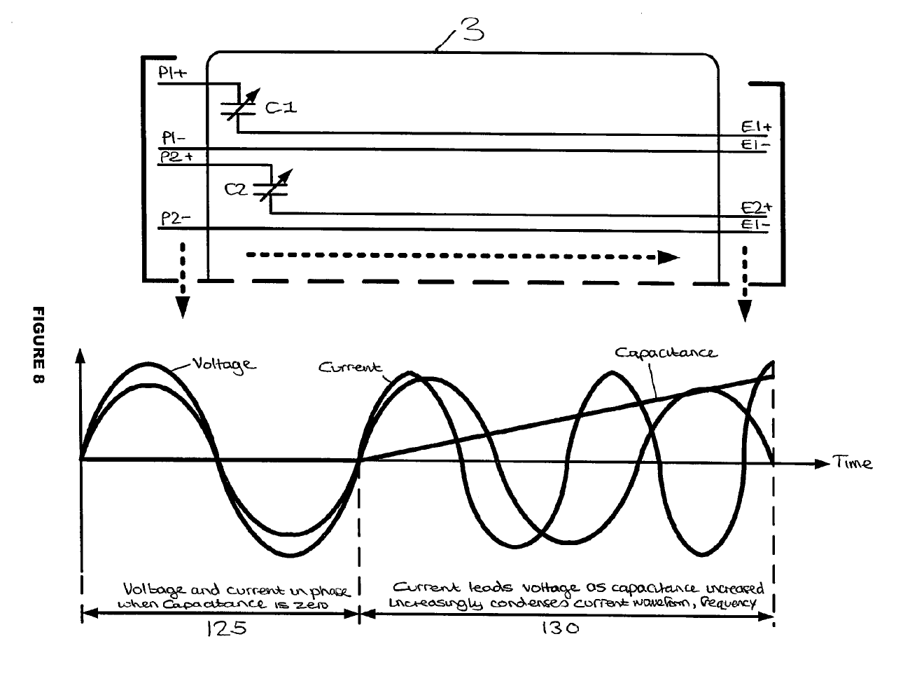

FIG. 8 schematically depicts an alternative embodiment of the connection circuit board 3 in which only the top half of the connection circuit board as described in FIG. 7 is shown. Instead of connecting the power coils 14 and the excitation coils 15 via the switches 110, the connection circuit board 3 of FIG. 8 uses variable capacitors such as super capacitors C1, C2 that can store additional power while varying the AC current frequency and wavelength leading the AC voltage. These AC power waveforms are shown in the graph at the bottom of FIG. 8, with the first section 125 showing no change in wavelength between current and voltage when capacitance is zero. The section 130 to the right of the graph shows that as capacitance is increased, it increasingly reduces or condenses the wavelength (increasingly increases the frequency) of the current leading the voltage. The super capacitors C1, C2 etc. are controlled by one or more of the digital controllers 40, 50 to control the voltage and current levels so that the current leads the voltage in the rotor, the current creating a magnetic flux in the induction rotor 20 of variable frequency and magnitude. The induction rotor 20 is in magnetic communication with the second set of magnetic coils 15. The power frequency and voltage control allows the motor of the device to operate at precisely controlled high capacities from the flywheel charging or discharging or, when operating in a generator mode, to provide a fixed frequency and voltage power supply PR ready for consumption without the use of a power converter.

A big advantage of this embodiment is that the AC current waveform and frequency can be varied to lead the voltage in almost any range up to typically 180 degrees out of phase. This provides greater control over the power transmission to perform advanced functions such as a constantly variable clutch that can more precisely and slowly transfer power together with a constantly variable transmission. The capacitors or super capacitors will store additional power to increase the flexibility of the response times of the digitally controlled motor such that the flywheel stores the shortest term power storage but is capable of providing huge power or boost capacity, the super capacitors provide intermediate power storage time with intermediate power capacity and the batteries provide the longest term power storage with the smallest power capacity. When all three storage types work in harmony any disadvantages of short storage time or small power capacity can be reduced to provide a well-rounded and increased ability to store and provide power for longer periods at high power capacities.

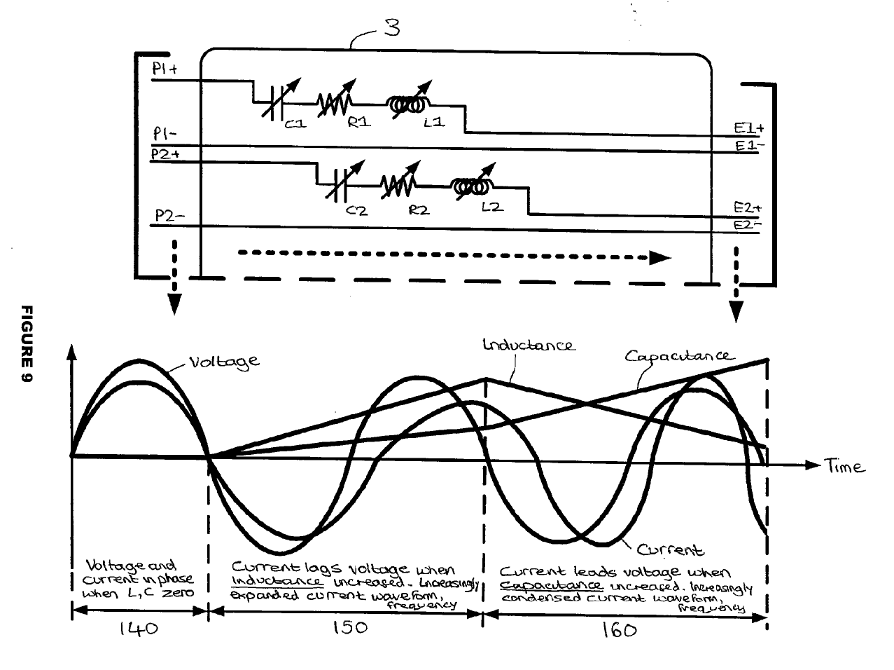

FIG. 9 shows a variation on the embodiment of the circuit board of FIG. 8 in which, in addition to the variable capacitors C1, C2 etc., the connections between the power coils 14 and the excitation coils 15 are achieved using variable resistors R1, R2 etc. and variable inductors L1, L2 etc. that are typically wired in series as shown but could also be wired in parallel or combinations thereof (not shown). In this wiring configuration, the AC current frequency and wavelength can lead or lag the AC voltage due to the amount of capacitance, resistance and inductance applied. These AC power waveforms are shown in the graph at the bottom of FIG. 9, with the first section 140 on the left showing no change in wavelength between current and voltage when capacitance, resistance and inductance is zero. The next section 150 to the middle of the graph shows that as capacitance is increased less than the corresponding inductance, it increasingly increases or expands the wavelength (increasingly reduces the frequency) of the current lagging the voltage. The values for resistance also affect this but are not shown as they have lesser effect and behave in a manner well known to those skilled in the art according to typical mathematical formulae. The section 160 at the right side of the graph shows that as capacitance is increased more than the corresponding inductance, it increasingly decreases or condense the wavelength (increasingly increases the frequency) of the current leading the voltage.

A further advantage of this embodiment compared to the embodiment in FIG. 8 is that the AC current waveform and frequency can be varied to lead or lag the voltage in almost any range up to typically 180 degrees out of phase. This provides the ultimate flexible control of the power voltage and frequency of the transmitted through the connection circuit board.

In any of the embodiments of FIGS. 7, 8 and 9, the connection circuit board 3 can be controlled to create more advanced functions for a car, truck or transport vehicle such as an electric clutch, constantly variable transmission (with practically infinite gearing), traction control, electronic stability programs and anti-lock braking (typically known as ABS). An advantage of using the connection circuit board 3 is more precise control of the mechanical power fed to the drive shaft or drive wheels with fast and efficient communication to other networked systems such as other similar digitally controlled motor devices that may be installed on each wheel of the vehicle and the car computer such as the engine control unit (ECU) controlling the internal combustion engine on a hybrid vehicle. In generation mode, other advanced features such as load balancing, power factor correction and voltage and frequency spike reduction can be created to control a number of generation devices to work together such as multiple wind turbines in a wind farm or many generators at different locations of an electrical grid to control the entire grid and localised power requirements via long distance communications such as the internet. The connection circuit board 3 introduces a large number of possible control algorithms that further enhance the flexibility and precise control of the digitally controlled motor or generator as a single device or a series of networked devices close by or far away from each other.

Each of the sets of magnetic coils described herein can be either permanent magnets or induction coils.

The stator/enclosure 70 may be surrounded by a water jacket (not shown in the Figures) in order to cool the device 1.

Although the invention has been described with reference to specific examples, it will be appreciated by those skilled in the art that the invention may be embodied in many other forms.

1. A digitally controlled motor device with storage, comprising:
a stator;
a flywheel having an axis of rotation and being rotatably mountable on a shaft of a rotating machine and having at least a first set of magnetic coils arranged thereon;
an induction rotor having an axis of rotation and being mountable on the shaft in magnetic communication with the first set of magnetic coils of the flywheel such that a change in magnetic flux at the first set of magnetic coils induces a current in the induction rotor;
at least one set of second magnetic coils arranged on the stator in magnetic communication with the induction rotor; and
a first controller for controlling a supply of electrical power from the flywheel to the second set of magnetic coils to force acceleration or deceleration of the induction rotor; whereby the induction rotor is adapted to receive electrical power from the flywheel via the first set of magnetic coils and from the second set of magnetic coils.

2. The digitally controlled motor device with storage of claim 1, wherein the shaft is a drive shaft.

3. The digitally controlled motor device with storage of claim 1 or claim 2, wherein the magnetic flux and associated electrical power experienced by said second set of magnetic coils is at an angular velocity ω_{RF} that is equal to the velocity of the induction rotor ω_{R} relative to the angular velocity of the flywheel ω_{F} and governed by the equation:
ω_{RF}=ω_{R}−ω_{F}

4. The digitally controlled motor device with storage of any one of claims 1 to 3, wherein the drive shaft is a drive shaft of a vehicle.

5. The digitally controlled motor device with storage of any one of claims 1 to 3, wherein the drive shaft is adapted for driving a compressor.

6. The digitally controlled motor device with storage of any one of claims 1 to 5, wherein a third set of magnetic coils is arranged on the flywheel and in electrical communication with the first controller for the transfer of electrical power to and from the flywheel.

7. The digitally controlled motor device with storage of any one of claims 1 to 6, further including an external electrical power storage device, the first controller adapted to supply electrical power from the external electrical power storage device to the flywheel or to transfer electrical power stored in the flywheel to the external electrical power storage device, the first controller being adapted to control the speed of rotation of the flywheel by controlling an amount of power supplied to the third set of magnetic coils.

8. The digitally controlled motor device with storage of any one of claims 1 to 7, further including a second controller adapted to supply electrical power to the induction rotor via the second set of magnetic coils.

9. The digitally controlled motor device with storage of claim 8, wherein each of the first controller and the second controller is a digitally controlled switched brushless motor controller.

10. The digitally controlled motor device with storage of either of claim 8 or 9, wherein the first controller and the second controller each include an induction rotor position sensor and an induction rotor speed sensor.

11. The digitally controlled motor device with storage of any one of claims 8 to 10, wherein the first and second controllers include at least one rotary encoder and/or magnetic hall sensor.

12. The digitally controlled motor device with storage of any one of claims 8 to 11, wherein the first controller and the second controller are in electrical communication with each other.

13. The digitally controlled motor device with storage of claim 6, further including a fourth set of magnetic coils connected to the stator in electrical communication with the external electrical power storage device for transfer of electrical power to or from the flywheel via the third set of magnetic coils.

14. The digitally controlled motor device with storage of claim 7, wherein the external electrical power storage device is a battery or a super capacitor.

15. The digitally controlled motor device with storage of any one of claims 1 to 14, further including at least one bearing connected to the stator for supporting the flywheel in controlled rotation about its axis of rotation.

16. The digitally controlled motor device with storage of any one of claims 1 to 15, wherein the magnetic coils are permanent magnets.

17. The digitally controlled motor device with storage of any one of claims 1 to 15, wherein the magnetic coils are induction coils.

18. The digitally controlled motor device with storage of claim 2, wherein the drive shaft has an axis of rotation and the device includes at least one bearing connected to the stator for supporting the drive shaft in controlled rotation about its axis of rotation.

19. The digitally controlled motor device with storage of claim 13, wherein the first, second, third and fourth sets of magnetic coils and the induction rotor are arranged in a radial flux configuration.

20. The digitally controlled motor device with storage of claim 13, wherein the third and fourth set of coils may be arranged in a transverse flux configuration.

21. The digitally controlled motor device with storage of any one of claims 1 to 20, wherein the stator includes an enclosure around the device components.

22. The digitally controlled motor device with storage of claims 21, wherein the enclosure includes a mechanical seal to seal the induction rotor, flywheel and drive shaft therein.

23. The digitally controlled motor device with storage of claim 21 or claim 22, wherein the apparatus further includes a non-return valve and a vacuum pump adapted for placing the enclosure and stator under a full or partial vacuum.

24. The digitally controlled motor device with storage of any one of claims 1 to 23, wherein the apparatus includes a water jacket arranged outside the stator and enclosure. The water jacket absorbs heat generated inside the stator and enclosure by the magnetic coils and the induction rotor.

25. The digitally controlled motor device with storage of any one of claims 1 to 20, wherein the enclosure is hermetically sealed and a magnetic coupling is used to transmit power from inside the enclosure to an external shaft thereby eliminating mechanical seals.

26. The digitally controlled motor device with storage of any one of claims 1 to 25, wherein the induction rotor is operatively associated with a plurality of turbine rotor blades for rotational movement therewith as the turbine blades are rotated by fluid movement.

27. The digitally controlled motor device with storage of claim 6, wherein the number of coils in the first set of magnetic coils differs from the number of coils in the third set of magnetic coils so as to produce a geared ratio of the coils installed on the flywheel.

28. The digitally controlled motor device with storage of claim 27, wherein the number of third magnetic coils is a multiple of the number of first magnetic coils.

29. The digitally controlled motor device with storage of any one of claims 1 to 28, wherein the induction rotor has a flywheel side in electrical communication with the first set of magnetic coils and a stator side in electrical communication with the second set of magnetic coils.

30. The digitally controlled motor device with storage of any one of claims 1 to 29, wherein the induction rotor has a first number of induction coils at the flywheel side thereof and a second number of induction coils at the stator side thereof.

31. The digitally controlled motor device with storage of claim 30, wherein the number of induction coils on the stator side is different to the number of induction coils on the flywheel side.

32. The digitally controlled motor device with storage of claim 31, wherein the number of induction coils on the stator side is a multiple of the number of coils on the flywheel side.

33. The digitally controlled motor device with storage of any one of claims 1 to 32, further including a first section that includes a first enclosure and the flywheel and a separate second section that includes a second enclosure and the induction rotor.

34. The digitally controlled motor device with storage of claim 33, further including a connection circuit board arranged in electrical communication with each of the flywheel and the induction rotor.

35. The digitally controlled motor device with storage of claim 34, wherein the first section includes a fifth set of magnetic coils mounted on the enclosure in magnetic communication with the first set of magnetic coils of the flywheel.

36. The digitally controlled motor device with storage of claim 35, wherein the second section includes a sixth set of magnetic coils mounted on the second enclosure in magnetic communication with the induction rotor.

37. The digitally controlled motor device with storage of claim 36, wherein the connection circuit board is adapted to transmit electrical power from the fifth set of magnetic coils to the induction rotor via the sixth set of magnetic coils.

38. The digitally controlled motor device with storage of any one of claims 1 to 33, further including a connection circuit board located inside the induction rotor, the connection circuit board being adapted to transmit electrical power between the flywheel first set of magnetic coils and the induction rotor via the second set of magnetic coils.

39. The digitally controlled motor device with storage of claim 38 when dependent upon claim 8, wherein the connection circuit board is controlled wirelessly via either of the first controller or the second controller located outside of the stator.

40. The digitally controlled motor device with storage of claim 34 or claim 38 or claim 39, wherein the connection circuit board includes a programmable logic controller adapted for conditioning of electrical power transmitted between the flywheel and the induction rotor.

41. The digitally controlled motor device with storage of claim 40, wherein the programmable logic controller is adapted to control a plurality of electrical and/or mechanical switches to obtain a change in frequency and voltage of electrical power transmitted through the induction rotor.

42. The digitally controlled motor device with storage of claim 40 or claim 41, wherein the programmable logic controller is adapted to control a plurality of variable capacitors for obtaining a change in the voltage, current level and frequency at the induction rotor such that the current leads the voltage to cause a magnetic flux in the induction rotor of variable frequency and magnitude.

43. The digitally controlled motor device with storage of claim 40 or claim 41, wherein the programmable logic controller has a plurality of variable inductors, variable resistors and variable capacitors and is adapted to control the current, voltage level and frequency of the plurality of variable inductors, resistors and capacitors such that the current leads or lags the voltage at the induction rotor such that the current creates a magnetic flux in the induction rotor of variable frequency and magnitude.

44. The digitally controlled motor device with storage of claim 42 or claim 43, wherein the variable capacitors and/or the variable inductors further function to store electrical power.
